(19) United States
(12) Patent Application Publication
(10) Pub. No.: US 2012/0080225 A1
(43) Pub. Date: Apr. 5, 2012

(54) CABLE FOR ELECTRICAL AND OPTICAL TRANSMISSION

(75) Inventors: Min Chul Kim, Santa Clara, CA (US); Vince Duperron, Cupertino, CA (US)

(73) Assignee: Apple Inc., Cupertino, CA (US)

(21) Appl. No.: 12/895,842

(22) Filed: Sep. 30, 2010

(51) Int. Cl. H01B 7/00; G02B 6/04

(52) U.S. Cl. 174/70 R; 264/1.28

(57) ABSTRACT

Circuits, methods, and apparatus that provide cables capable of high-speed transmission while remaining compatible with legacy signals. Other examples may have shielding that may be easily manipulated during manufacturing, they may have good tensile strength, and they may be less likely to be damaged by twisting and bending that may occur during use.

### BACKGROUND

The amount of data transferred between electronic devices has grown tremendously the last few years. Large amounts of audio, video, text, and other types of data content, are now regularly transferred among computers, media devices, such as handheld media devices, displays, storage devices, and other types of electronic devices. Since it is often desirable to transfer this data rapidly, the data rates of these transfers have substantially increased.

This data is often transferred over cables. Unfortunately, these cables may not be capable of conveying signals at these higher data rates. But while improved cables capable of operating at higher speeds are desirable, it is often useful to be backward compatible with older or legacy technologies. Accordingly, it is desirable to have cables that can operate at these higher data rates while remaining compatible with legacy technologies.

One feature common to cables is the use of a braided shield. This shield may be placed around one or more center conductors of the cable. This shield is typically braided, that is, it is typically formed of interwoven wire.

But this weave can be difficult to manipulate during cable manufacturing. For example, during cable manufacturing, the braiding may be pulled apart and soldered to form a ground connection with one or more strain-reliefs, circuits, connector pins, or other circuits or cable components. Since the braiding is woven, it may be difficult to pull apart and solder. Accordingly, it is desirable to have a shield that is more easily manipulated during manufacturing.

One difficulty encountered with cables is that they may be pulled, stretched, twisted, or bent. This may damage or break either the cable or one or more internal conductors. Accordingly, it is also desirable to have cables that have increased strength and are less likely to be damaged by twisting or bending.

Thus, what is needed are circuits, methods, and apparatus that provide cables capable of high-speed transmission while remaining compatible with legacy signals, have shielding that may be easily manipulated during manufacturing, have good tensile strength, and are less likely to be damaged by twisting and bending that may occur during use.

### SUMMARY

Accordingly, embodiments of the present invention may provide circuits, methods, and apparatus that provide cables capable of high-speed transmission while remaining compatible with legacy signals. Embodiments of the present invention may have shielding that may be easily manipulated during manufacturing. Embodiments of the present invention may have good tensile strength, and may be less likely to be damaged by twisting and bending that may occur during use.

An illustrative embodiment of the present invention may provide a cable having both fiber-optic cables and electrical conductors. The fiber-optic cables may be useful in conveying high-speed signals that are compliant with current and newly developing signaling standards. The electrical conductors may be useful in conveying signals compliant with current or legacy standards, such as USB2.

To increase cable flexibility of various embodiments of the present invention, the fiber-optic cables may be twisted around each other. Further, to reduce the losses incurred by this twisting, the fiber-optic cables may be annealed. In one specific embodiment of the present invention, this annealing may occur during the encapsulation of the cable in a jacket. The fiber-optic cables may be formed of glass, polytetrafluoroethylene, or other material.

In various embodiments of the present invention, the electrical conductors may have different diameters. For example, the power conductors may have a large diameter to increase the conductor's current-carrying capability. Data or signal conductors may have a smaller diameter to limit the cross talk and capacitance.

Another illustrative embodiment of the present invention may include and arrange conductors and other materials such that the cable has a relatively rounded cross section. This may help limit damage that may occur due to bending and twisting of the cable. Specifically, embodiments of the present invention may include additional conductors. For example, additional power conductors may be included. In other embodiments of the present invention, fillers or other fibers may be included. These may be formed of cotton, aramid, or other materials.

Another illustrative embodiment of the present invention may include reinforcing members for strength. For example, the aramid fillers mentioned above may be used to provide a rounded cross section as well as increased strength. These or other fibers may also be used in the electrical conductors.

Another illustrative embodiment of the present invention may use multiple counter-rotating spirals as a shield in place of a conventional braid. This may provide increased flexibility and may be easily manipulated during cable manufacturing.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates various layers of a high-speed cable according to an embodiment of the present invention;

FIG. 2 illustrates a cross-section of a cable according to an embodiment of the present invention;

FIG. 3 illustrates a side view of a portion of the cable according to an embodiment of the present invention;

FIG. 4 illustrates a cross-section of a cable according to an embodiment of the present invention;

FIG. 5 illustrates a detailed view of fiber optic cables that may be employed by cables according to an embodiment of the present invention;

FIG. 6 illustrates a side view of two fiber-optic cables wrapped around each other; and

FIG. 7 illustrates a method of manufacturing a cable according to an embodiment of the present invention.

### DESCRIPTION OF ILLUSTRATIVE EMBODIMENTS

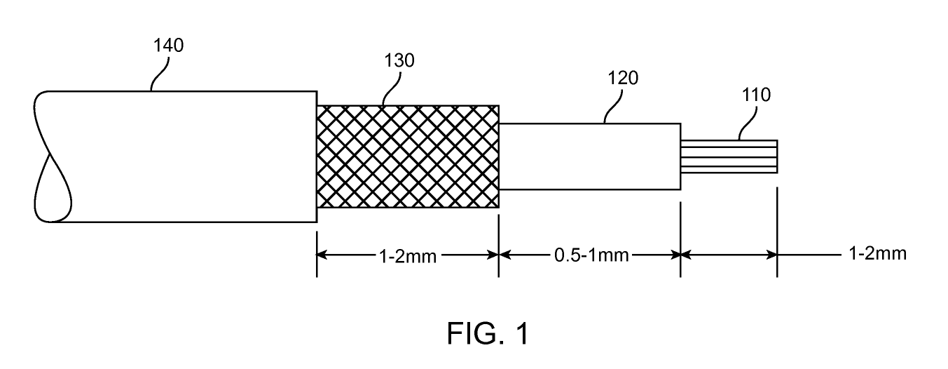

FIG. 1 illustrates various layers of a high-speed cable according to an embodiment of the present invention. This cable includes center conductors 110, dielectric 120, shield 130, and jacket 140. Center conductors 110 may include single conductors, coaxial conductors, or pairs of conductors, such as twinaxial, twisted-pair, shielded twisted pair, or other pairs of conductors. The conductors may convey power, data, status or other information. The conductors may be single wires or multiple strands of wires. In some embodiments of the present invention, one or more conductors may be formed of a group of strands of wires, where each wire is coated with a layer of material to provide spatial separation among the strands. This separation aids in limiting skin effects and thus limits skin effects. This layer of material may be enamel or other material. The wires may be arranged as a Litz wire. Each of these various conductors may be formed of copper, aluminum, or other conductive material. They may be coated or plated with a layer to protect the wire from oxidation, for example, they may be plated with silver.

Dielectric 120 may be included to isolate shield 130 from center conductors 110. Selection of a low-loss tangent dielectric 120 may increase isolation and reduce capacitance coupling effects between center conductors 110 and shield 130 as compared to a lower-quality, higher-loss tangent dielectric.

Shield 130 may provide a ground path through the cable. Shield 130 may also provide electrical isolation (or RF shielding or isolation) for the center conductors 110. This isolation may protect the center conductors 110 from receiving noise and spurious signals, and the isolation may protect other lines or circuits from noise and spurious signals generated on the center conductors 110. Jacket 140 may be used to insulate shield 130, to provide mechanical support, and to provide a tactile surface for users to manipulate.

Again, embodiments of the present invention may provide improved cables. These cables may include reinforcing members for improved strength. They may include conductors for power and data transmission. They may employ fibers or other filler material such that the cable has an approximately rounded cross-section. The cables may also be shielded in a manner that provides for easy manipulation during manufacturing. An example is shown in the following figure.

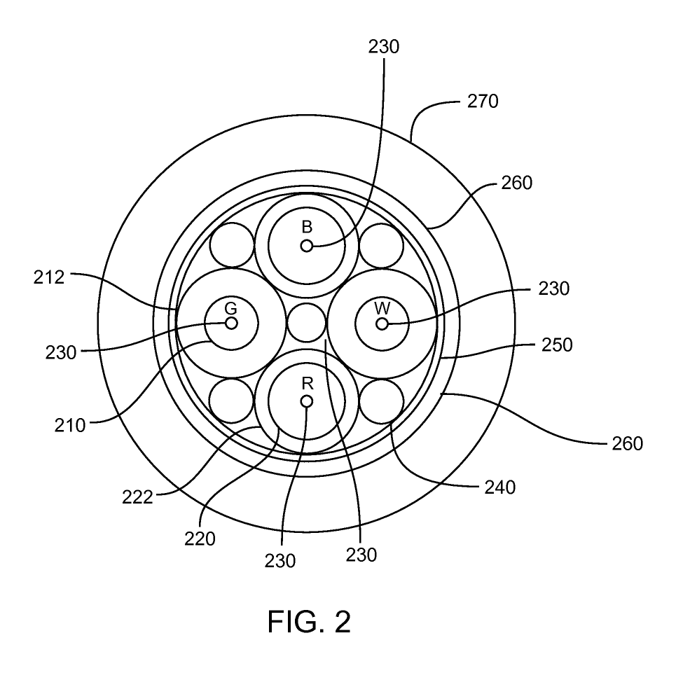

FIG. 2 illustrates a cross-section of a cable according to an embodiment of the present invention. This cable may include data conductors 210, power conductors 220, reinforcing members (shown here as aramid fibers) 230, and filler 240. Conductors 210 and 220, aramid fibers 230, and filler 240, may be wrapped in Mylar layer 250. Counter-rotating spirals may provide a shield 260, which may be encapsulated by jacket 270.

Data connectors 210 may be insulated by insulating layers 212. Conductors 210 may be relatively narrow to reduce capacitance from the conductor 210 to the other connectors 210 and 220, shield 260, as well as external conductors.

Power conductors 220 may be insulated by insulating layers 222. Connectors 220 may be relatively wide to handle relatively large amounts of current.

Reinforcing members 230 may also be included to provide increased cable strength. Again, in this example, the reinforcing members are aramid fibers 230. Aramid fibers 230 may be located inside one or more of conductors 210 and 220. Aramid fibers 230 may also be located between or around conductors 210 and 220. In this specific example, one of aramid fibers 230 may be located between conductors 210 and 220.

It may be desirable that these cables have a relatively rounded cross section. This rounded shape may improve cable flexibility and reliability. Accordingly, a number of fillers 240 may be used. These fillers may be polytetrafluoroethylene, cotton, or they may be formed of other types of material.

Connectors 210 and 220, fibers 230, and filler 240, may be wrapped in Mylar layer 250. Mylar layer 250 may keep the bundle of individual conductors, fibers, and filler together during manufacturing.

Again, it may be desirable to provide a shield to isolate conductors 210 and 220 from external noise sources, as well as to prevent noise and spurious signals on conductors 210 and 220 from radiating away from the cable. It may also be desirable to have a shield that is easily manipulated during manufacturing. For example, each end of these cables may be connected to a connector plug during manufacturing. As part of this connection, the shield may be soldered to a portion of one or more of these connector plugs. Accordingly, it may be desirable that the shield be easily handled such that it may be connected in this way.

Accordingly, various embodiments of the present invention employ wires in counter-rotating spirals, such as counter-rotating spirals 260. Counter-rotating spirals may comprise two layers of wires wrapped in opposing directions. By having the wires wrapped in this way, as opposed to a conventional braiding, wires in the shield may be easily manipulated during manufacturing. That is, the wires may be easily unwound from around the inside conductors. While various embodiments of the present invention utilize these counter-rotating spirals, other embodiments of the present invention may employ conventional braiding or other shielding techniques.

Jacket 270 may be extruded around the cable for mechanical support and handling by a user.

Again, embodiments of the present invention may employ two counter-rotating spirals as a shield. An example is shown in the following figure.

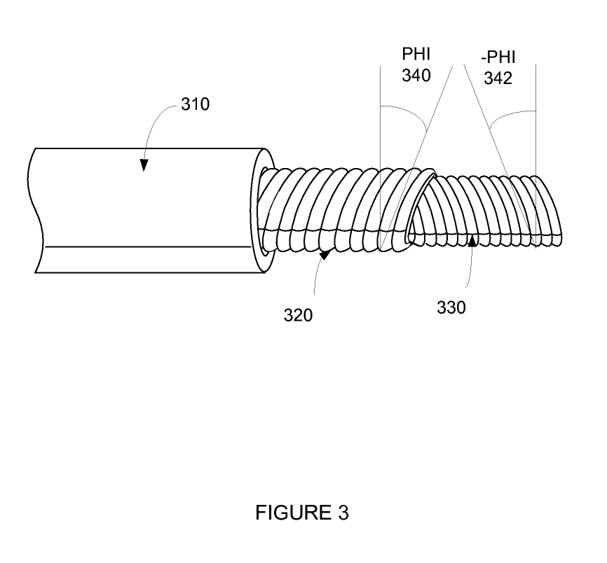

FIG. 3 illustrates a side view of a portion of the cable according to an embodiment of the present invention. This figure illustrates a cable surrounded by jacket 310. Jacket 310 has been cut away to reveal a first counter-rotating spiral 320 and a second counter-rotating spiral 330. The first of these spirals may have an angle approximately equal to phi 340. In a specific embodiment of the present invention, phi may be equal to 17 degrees. In other embodiments of the present invention, other angles may be used. The second of these may have approximately the same relative angle, shown here as negative phi 342 to indicate a different absolute direction.

In this way, during manufacturing, the wires in the counter-rotating spirals 320 and 330 may be easily peeled away, straightened, and soldered or otherwise electrically connected to locations in a connector plug.

Utilizing counter-rotating spirals 320 and 330 may also improve flexibility of the cable. For example, when the cable is twisted in a first direction, counter-rotating spiral 320 may tighten while counter-rotating spiral 330 may loosen. The tightening of counter-rotating spiral 320 may protect the internal conductors. Similarly, when the cable is twisted in a second direction, counter-rotating spiral 330 may tighten while counter-rotating spiral 320 may loosen. The tightening of counter-rotating spirals 330 may protect the internal conductors.

Again, data rates for signals over these cables have been increasing at a tremendous rate. Accordingly, improvements to these cables may be needed to handle the higher data rates. But it is often desirable to be able to support legacy standards. Accordingly, embodiments of the present invention may provide cables that are capable of these higher data rates while still supporting legacy standards. An example is shown in the following figure.

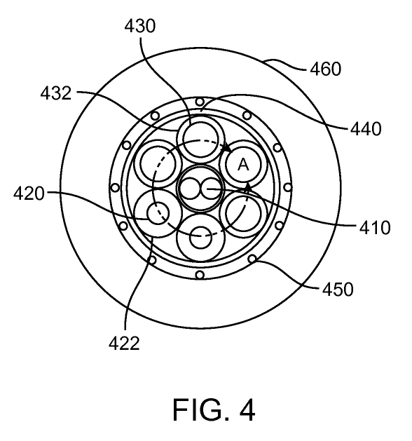

FIG. 4 illustrates a cross-section of a cable according to an embodiment of the present invention. This figure may include fiber optic cables 410, data conductors 420, power conductors 430, shield 440, Mylar layer 450, and jacket 460.

Fiber-optic cables 410 are capable of handling very high data rates. In this example, two fiber-optic cables may be included for full duplex communication. In other embodiments of the present invention, one cable, or more than two cables, may be included. These fiber-optic cables may be glass, polytetrafluoroethylene, or other material. In a various embodiments of the present invention, these fiber-optic cables may be used to convey signals that are consistent with standardized or proprietary signaling schemes that have been developed, are currently being developed, or will be developed in the future.

While fiber-optic cables 410 are capable of handling high data rates, many current electronic devices communicate over electrical conductors. For example, USB1 and USB2 devices communicate using electrical conductors. Accordingly, embodiments of the present invention also include electrical conductors for conveying signals according to legacy standards, such as USB1 and USB2.

Accordingly, this specific example includes electrical conductors 420. As before, electrical conductors 420 may be relatively narrow to reduce parasitic capacitances. These electrical conductors may be isolated by insulation layers 422. Power conductors 430 may be relatively wide to increase current handling capabilities. Power conductors 430 may be insulated by isolation layers 432. Electrical conductors 420 and 430 may be single wires, or multiple strands of wires. In some embodiments of the present invention, one or more conductors may be formed of a group of strands of wires, where each wire is coated with a layer of material to provide spatial separation among the strands. This separation aids in limiting skin effects and thus limits skin effects. This layer of material may be enamel or other material. The wires may be arranged as a Litz wire. Each of these various conductors may be formed of copper, aluminum, or other conductive material. They may be coated or plated with a layer to protect the wire from oxidation, for example, they may be plated with silver.

As before, Mylar layer 440 may be used to hold the conductors and fiber-optic cables together during manufacturing. Fillers and fibers (not shown), such as aramid fibers, may be used to provide a rounded cross section and reinforcement. For example, the aramid or other types of fibers may be included around, among, or inside the various cables and conductors of embodiments of the present invention.

Shield 450 may be used to isolate conductors 420 and 430. This shielding may be formed using conventional techniques, such as braiding. In other embodiments of the present invention, counter-rotating spirals may be used, as shown above. Jacket 460 may be extruded around the cable for mechanical support and handling by a user.

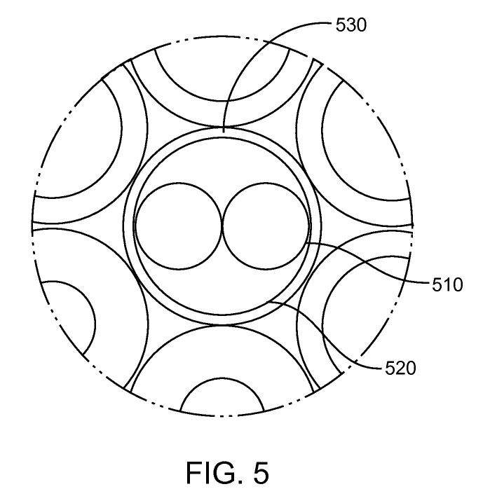

FIG. 5 illustrates a detailed view of fiber optic cables 510 that may be employed by cables according to an embodiment of the present invention. Cables 510 may be mechanically supported by filler 520. Fiber-optic cables 510 and fillers 520 may be wrapped by Mylar film 530 for mechanical support during manufacturing.

Fiber optic cables 510 may be wrapped around each other. This may improve flexibility of the overall cable. For example, if fiber-optic cables 510 are parallel to each other throughout the cable, when the cable is bent, a fiber-optic cable inside the bending radius may experience a compression force, while a fiber-optic cable outside the bending radius may experience an expansion force. These differential forces may damage the cable. By twisting or wrapping the cables around each other, these compression and expansion forces may be distributed along the length of the cable, thereby improving cable reliability. An example is shown in the following figure.

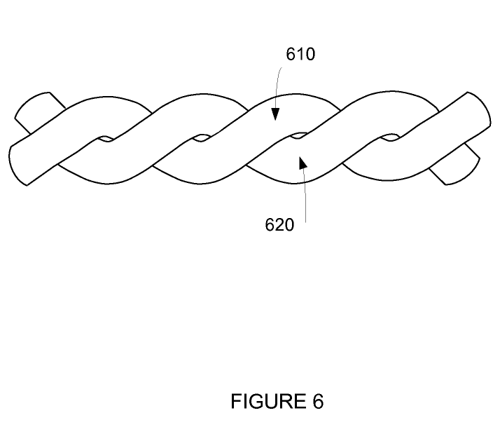

FIG. 6 illustrates a side view of fiber-optic cables 610 and 620 wrapped around each other. As fiber-optic cables 610 and 620 are bent, compression and expansion forces are distributed along the length of the fiber-optic cables, thereby improving overall cable flexibility and reliability.

Unfortunately, twisting fiber-optic cables in this way can increase their loss significantly. Accordingly, embodiments of the present invention anneal these fiber-optic cables after twisting to reduce this loss. In a specific embodiment of the present invention, this annealing occurs during jacket extrusion. An example is shown in the following figure.

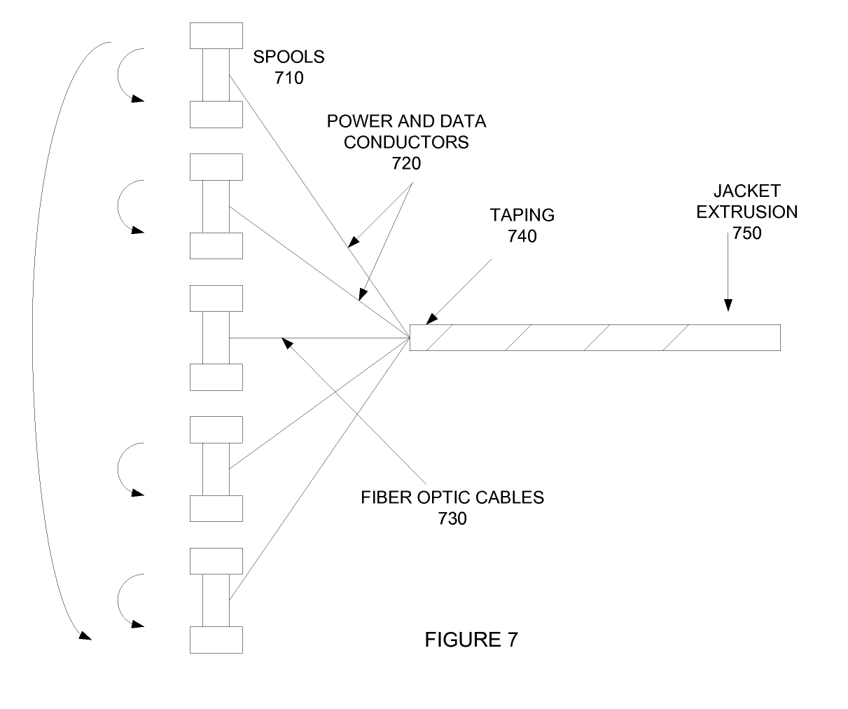

FIG. 7 illustrates a method of manufacturing a cable according to an embodiment of the present invention. A number of spools 710 may provide power and data conductors 720 and fiber-optic cables 730 for a cable. Power and data conductors 720 and fiber-optic cables 730 may be bound together by taping 740. Jacket extrusion 750 may extrude a jacket over the cable for mechanical support and manipulation by a user.

In this embodiment of the present invention, fiber-optic cables 730 may be held in place, that is, they are not twisted, as the cable is assembled. Power and data conductors 720 may be twisted around two fiber-optic cables 730. This may prevent further losses in fiber-optic cables 730.

Again, embodiments of the present invention may employ annealing to reduce losses in fiber-optic cables 730 due to their being twisted together, as shown in FIG. 6. In a specific embodiment of the present invention, this annealing is achieved during jacket extrusion 750.

Specifically, the jacket may be a halogen-free material. Due to the properties of halogen-free materials, the jacket may be extruded at a slower rate than would otherwise be necessary for a material that includes halogens. Also, in various embodiments of the present invention, the temperature at jacket extrusion 750 may be higher than would otherwise be necessary. This slower rate and possibly higher temperature provides for annealing of fiber-optic cables 730.

The losses incurred by twisting fiber-optic cables 730 may be increased if excessive tension is placed on fiber-optic cables 730 during construction of the cable. Accordingly, various embodiments of the present invention may reduce the tension placed on fiber-optic cables 730 during construction. A specific embodiment of the present invention may maintain no more tension on the fiber-optic cables 730 than is necessary for the construction of the cable.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A cable comprising
a plurality of fiber-optic cables, each wrapped around the other;
a plurality of electrical conductors; and
a shield surrounding the plurality of fiber-optic cables and the plurality of electrical conductors.

2. The cable of claim 1 wherein the plurality of fiber-optic cables comprises two fiber-optic cables.

3. The cable of claim 1 wherein the fiber-optic cables are polytetrafluoroethylene (PTFE).

4. The cable of claim 1 wherein the fiber-optic cables are glass.

5. The cable of claim 1 wherein the plurality of electrical conductors comprises a plurality of electrical conductors for power and a plurality of electrical conductors for data.

6. The cable of claim 1 wherein the plurality of electrical conductors comprises four electrical conductors for power and two electrical conductors for data.

7. The cable of claim 1 wherein the shield comprises at least two pluralities of conductors wrapped as counter-rotating spirals.

8. The cable of claim 1 wherein the shield comprises a first plurality of wires wrapped in a first direction at a first angle and a second plurality of wires wrapped in a second direction.

9. The cable of claim 8 wherein the first angle is approximately 17 degrees.

10. The cable of claim 9 wherein the second plurality of wires are wrapped at an angle that is approximately negative 17 degrees.

11. The cable of claim 1 further comprising a plurality of reinforcing members.

12. The cable of claim 11 wherein at least one reinforcing member is located in one of the plurality of conductors.

13. The cable of claim 11 wherein the reinforcing members are aramid fibers.

14. A cable comprising:
a plurality of conductors;
a plurality of fillers arranged among the plurality of conductors such that the cable has approximately a rounded cross-section;
a plurality of reinforcing members; and
a shield comprising at least two pluralities of conductors wrapped as counter-rotating spirals.

15. The cable of claim 14 wherein at least one reinforcing member is located in one of the plurality of conductors.

16. The cable of claim 15 wherein the at least one reinforcing member is an aramid fiber.

17. The cable of claim 16 further comprising:
a jacket surrounding the shield, wherein the jacket is a halogen-free material.

18. The cable of claim 14 wherein the plurality of conductors comprises a first plurality of power conductors and a second plurality of data conductors.

19. A method of manufacturing a cable comprising:
twisting a plurality of fiber-optic cables around each other;
twisting a plurality of conductors around the plurality of fiber-optic cables while preventing the plurality of fiber-optic cables from twisting;
annealing the plurality of fiber-optic cables.

20. The method of claim 19 wherein twisting the plurality of fiber-optic cables comprises twisting two polytetrafluoroethylene cables.

21. The method of claim 19 wherein twisting the plurality of conductors around the plurality of fiber-optic cables comprises planetary twisting the plurality of conductors around the plurality of fiber-optic cables.

22. The method of claim 19 wherein annealing the plurality of fiber-optic cables comprises extruding a jacket to cover the plurality of conductors and the plurality of fiber-optic cables.

23. The method of claim 19 wherein twisting a plurality of conductors around the plurality of fiber-optic cables comprises twisting a plurality of power conductors and twisting a plurality of data conductors.

24. The method of claim 19 further comprising:
before annealing the plurality of fiber-optic cables, taping the plurality of conductors and the plurality of fiber-optic cables.
